(19) United States
(12) Patent Application Publication
(10) Pub. No.: US 2026/0138271 A1
(43) Pub. Date: May 21, 2026

(54) INFORMATION PROCESSING METHOD, INFORMATION PROCESSING APPARATUS, RECORDING MEDIUM, AND ARTICLE MANUFACTURING METHOD

(71) Applicant: CANON KABUSHIKI KAISHA, Tokyo (JP)

(72) Inventor: HIRONOBU SASAKI, Kanagawa (JP)

(21) Appl. No.: 19/375,013

(22) Filed: Oct. 30, 2025

(30) Foreign Application Priority Data
Nov. 15, 2024 (JP) 2024-199494

(51) Int. Cl. B25J 9/16

(52) U.S. Cl. CPC B25J 9/163; B25J 9/1671

(57) ABSTRACT

An information processing method includes acquiring, in a case where a condition of a teaching point in an operation of a robot is changed, an operation command related to the teaching point of which the condition has been changed and issuing a notification of the acquired operation command that causes a predetermined state.

### BACKGROUND

### Field of the Technology

The present disclosure relates to an information processing method, an information processing apparatus, and a recording medium, and an article manufacturing method.

### Description of the Related Art

In order to cause a robot to operate, it is necessary to register teaching points, which are information indicating the position and orientation of the robot, and to describe operation commands using the teaching points in a robot program. If the conditions of the teaching points are incorrect, or operation commands are described using incorrect teaching points, there is possibility that the robot may enter a state that interferes with the operation of the robot, such as contact with an obstacle, passing through a singular point, or being outside the movable range. For this reason, a method for verifying whether the described operation commands are appropriate has been desired. Japanese Patent Laid-open No. 2015-98076 describes a method for presenting to a user whether newly described operation commands may cause contact with an obstacle or passing through a singular point by the robot.

A robot operation may involve adjusting or modifying the motion, which can include changing conditions such as the positions of teaching points.

When the conditions of the teaching points are changed, the trajectory of the robot changes accordingly, and it becomes necessary to re-verify whether the robot may enter the state that interferes with its operation as described above. Since a single teaching point may be used for a plurality of operation commands, there is a case where the robot trajectory may change over a plurality of operation commands. As a result, verifying the operation commands in which the trajectory changes has required a significant amount of work.

### SUMMARY

According to an aspect of the present disclosure, an information processing method includes acquiring, in a case where a condition of a teaching point in an operation of a robot is changed, an operation command related to the teaching point of which the condition has been changed and issuing a notification of the acquired operation command that causes a predetermined state.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an information processing apparatus for performing robot teaching according to a first embodiment.

FIG. 2 is a schematic diagram illustrating a graphical user interface used for performing the robot teaching according to the first embodiment.

FIG. 3 is a flowchart illustrating a procedure for the robot teaching according to the first embodiment.

FIG. 4 is a flowchart illustrating a procedure for changing a robot teaching point according to the first embodiment.

FIG. 5 is a flowchart illustrating a procedure for acquiring an operation command according to the first embodiment.

FIG. 6 is a flowchart illustrating a procedure for presenting a correction proposal for an operation command according to a second embodiment.

FIG. 7 is a flowchart illustrating a procedure for generating the correction proposal for the operation command according to the second embodiment.

FIG. 8 is a schematic diagram illustrating a graphical user interface for presenting the correction proposal for the operation command according to the second embodiment.

### DESCRIPTION OF THE EMBODIMENTS

### First Embodiment

In a first embodiment, an example in which a plurality of teaching points is set in teaching software, operation commands using the teaching points are registered in an operation command list, and the teaching points subsequently changed will be described. In this example, the operation commands are registered in the operation command list instead of being described in a robot program. The operation commands may alternatively be described in the robot program.

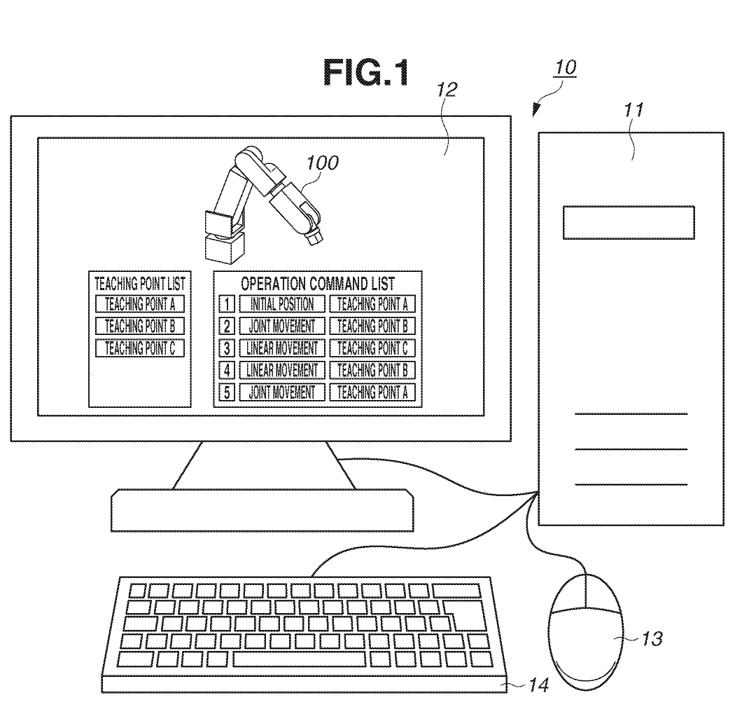

FIG. 1 is a schematic diagram illustrating an information processing apparatus for performing robot teaching. An information processing apparatus 10 includes a computer 11 for executing teaching software for a robot 100, a display 12 that serves as a display unit for displaying a user interface of the teaching software thereon, and a mouse 13 and a keyboard 14 used for inputting data into the teaching software. The robot 100 is taught using a teaching point generated using the information processing apparatus 10 and used for manufacturing articles.

While a desktop computer is used as an example of the computer 11, the information processing apparatus 10 may include a notebook personal computer (PC), a tablet PC, or a smartphone. The below-described processing is performed by a processing unit, such as a central processing unit (CPU), included in the computer 11.

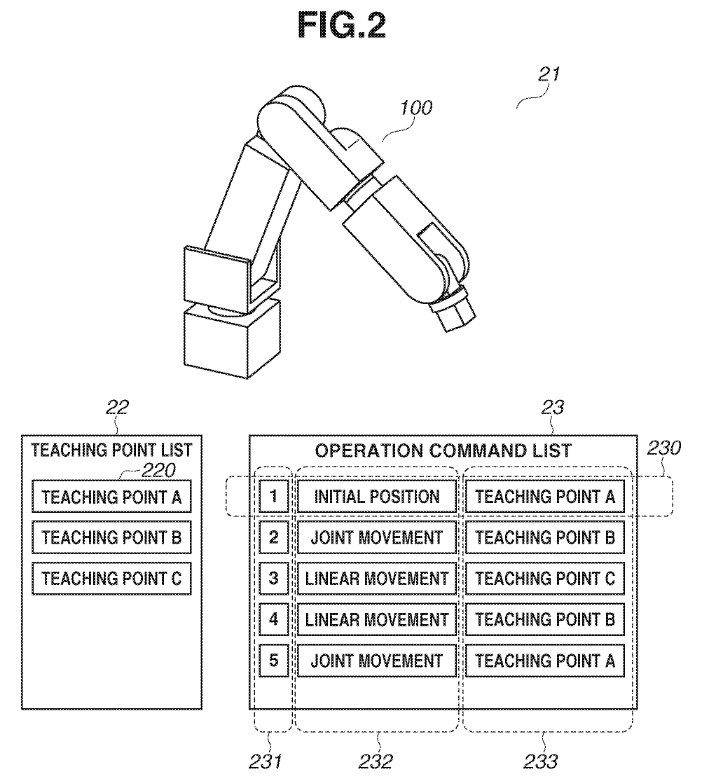

FIG. 2 illustrates a user interface of the program for performing the robot teaching. The user interface includes a main view 21 that represents the state of the robot 100, a teaching point list 22, and an operation command list 23. Teaching points 220 for the robot 100 are registered in the teaching point list 22. Operation commands 230 are registered in the operation command list 23. Each of the operation commands 230 consists of an operation command number 231, an operation command type 232, and a target position 233 of the operation. The registered operation commands 230 are executed in order of the operation command numbers 231.

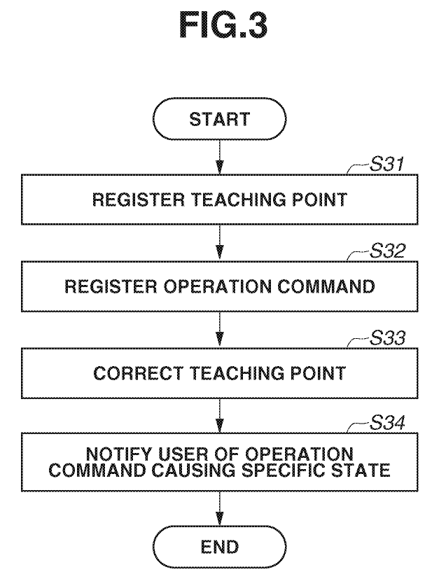

FIG. 3 is a flowchart illustrating the overall flow of the robot teaching. In the robot teaching for the robot 100, in step S31, a user first registers teaching points. Next, in step S32, the user registers an operation command for the robot 100. This completes the teaching process for the robot 100. In a case where conditions, such as the positions of the teaching points or the like, are changed due to adjustment or correction of the operation, in step S33, the user performs an operation of correcting the teaching points. In the present disclosure, in a case where the conditions, such as the positions of the teaching points or the like are changed, the operation commands related to the changed teaching points are acquired and simulated, and in a case where a predetermined state is detected, then in step S34, the user is notified thereof.

The predetermined state refers to a state that interferes with the operation of the robot, such as contact with an obstacle, passing through a singular point, or being outside the movable range, which is identified by performing a motion simulation using a generated robot trajectory.

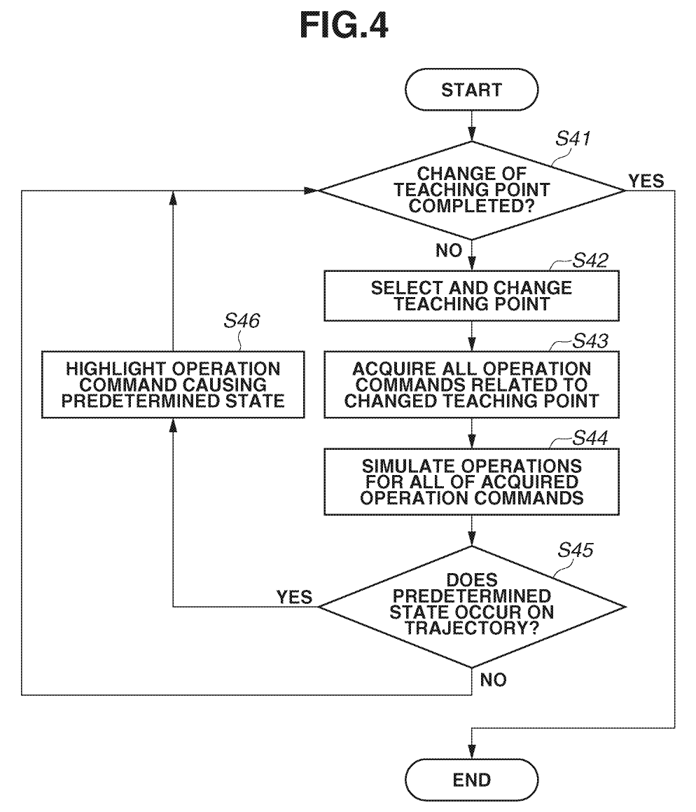

FIG. 4 is a flowchart illustrating a procedure for notifying the user of an operation command that causes the predetermined state due to the changes of the teaching points performed in step S34.

In step S41, it is determined whether the user has completed the changes of the teaching points. In a case where it is determined that the user has not completed the changes of the teaching points, i.e., the teaching points are to be changed (NO in step S41), the processing proceeds to step S42. In step S42, the user selects and changes one or more teaching points. In a case where it is determined that the user has completed the change of the teaching points (YES in step S41), the processing of the flowchart ends. In step S43, the information processing apparatus 10 acquires the operation commands related to the teaching points changed by the user. Next, in step S44, the information processing apparatus 10 simulates the operation of the robot 100 based on the acquired operation commands. In step S45, it is determined whether the robot 100 has entered the predetermined state in the simulation. In a case where it is determined that the robot 100 has entered the predetermined state (YES in step S45), the processing proceeds to step S46. In step S46, if the predetermined state has occurred, the corresponding operation command is highlighted to notify the user of the operation command in which the predetermined state has occurred. Then, the processing returns to step S41. In a case where it is determined that the robot 100 has not entered the predetermined state (NO in step S45), the processing returns to step S41.

The method of highlighting may, for example, display the operation command in which the predetermined state has occurred in red in the operation command list 23, or display the operation command in which the predetermined state has occurred in a separate list.

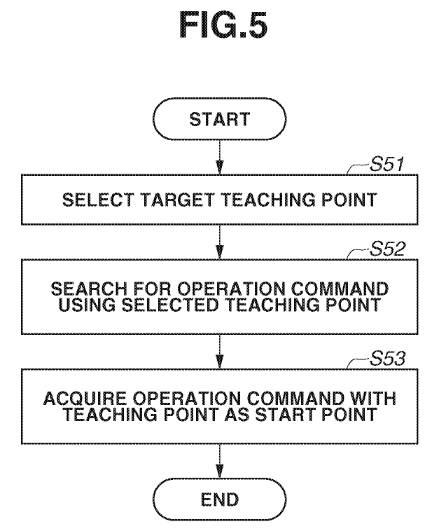

FIG. 5 is a flowchart illustrating a procedure for acquiring an operation command related to a certain teaching point.

In step S51, the user selects a target teaching point to be changed. In step S52, the system searches the operation command list for the teaching point selected by the user, and acquires an operation command that uses the teaching point. Next, in step S53, the system acquires an operation command having the teaching point selected as the change target by the user as a starting point, i.e., the operation command whose starting point has changed due to the change of the teaching point.

In the present embodiment, since the target position 233 of the operation is set for each of the operation commands, the next operation command acquired in step S52 becomes the operation command to be acquired in step S53. For example, as illustrated in FIG. 2, assume that teaching points A, B, and C are registered in the teaching point list 22, and assume that operation commands 1 to 5 are set in the operation command list 23.

In this case, when the user selects the teaching point A, the flow is as follows: in step S52, operation commands having the teaching point A as a target position, namely the operation command No. 1 and 5, are acquired; in step S53, the operation command No. 2, which is the next operation command following the operation command No. 1 acquired in step S52, is acquired. In this example, since the operation command No. 5 is the last command, no operation command following the operation command No. 5 is acquired. At this time, by displaying the operation commands acquired in steps S52 and S53 in a highlighted manner, the extent to which the teaching point selected by the user affects the entire operation of the robot 100 can be indicated in a simple manner, and therefore they may be displayed in a highlighted manner for convenience.

In the simulation performed in step S45, a motion simulation is performed for each of the acquired operation commands. A robot trajectory is generated using the operation command type 232, the target position 233 of the operation, and the target position 233 of the immediately preceding operation command.

For example, in step S44 in FIG. 4, assume that an operation command having the operation command No. 2 in the operation command list 23 in FIG. 2 has been acquired. To generate a robot trajectory from this operation command, the type of the operation command = joint movement, the target position of the operation = teaching point B, and the target position of the immediately preceding operation command = teaching point A are used. By performing a motion simulation using the generated robot trajectory, it is determined whether the robot 100 falls into the predetermined state that interferes with the operation of the robot 100, such as contact with an obstacle, passing through a singular point, or being outside the movable range.

Using the above-described method enables, in a case where the operation command causes the predetermined state by changing the teaching point condition, notifying the user of the operation command. Thus, it is possible to reduce the man-hours for checking the operation commands. The operation commands acquired in step S43 are not limited to the operation commands in which the teaching point has been changed. For example, a plurality of operation commands including operation commands before and after the operation command may be acquired simultaneously. In this way, even in a case where the influence of the change in the teaching point extends to the operation commands before and after the operation command, it is possible to reduce the man-hours for checking the operation commands.

### Second Embodiment

Assume that the robot 100 contacts an obstacle in a certain command as a result of the teaching point being changed by the user. In this case, for example, the user may restore the teaching point to its original state, or add an operation command to implement an avoidance operation for the obstacle that causes the contact. Since adding an operation command is a time-consuming operation, automatization is desired. In such a case, it is useful to automatically generate an operation command that implements an obstacle avoidance trajectory and present it to the user.

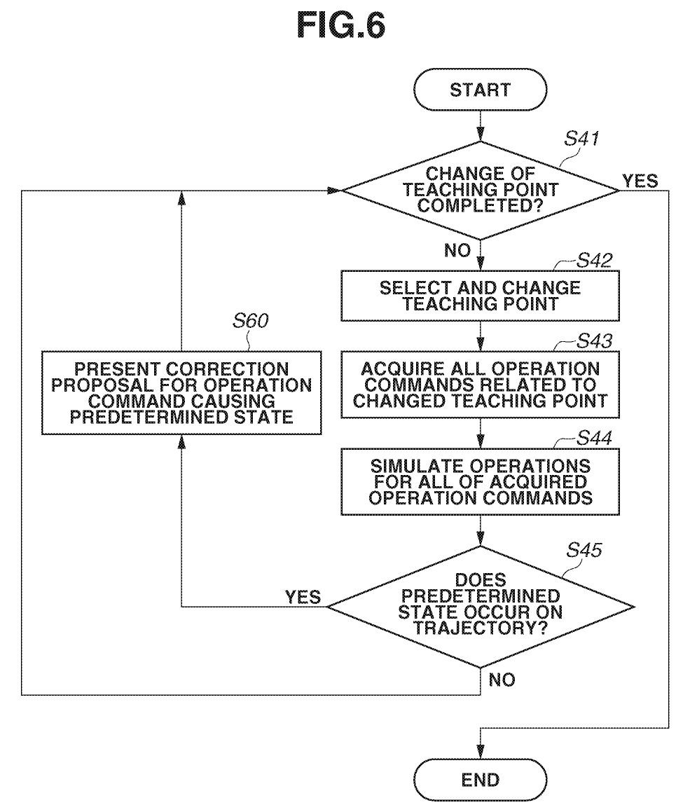

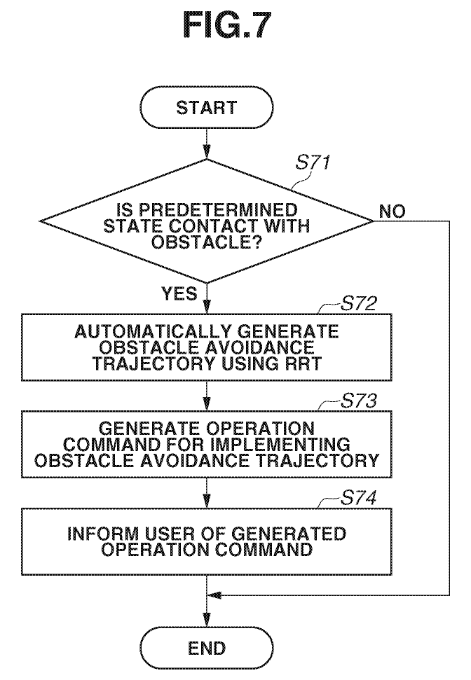

FIG. 6 is a flowchart illustrating a flow for presenting a correction proposal for the predetermined state caused by the change of a teaching point to the user according to a second embodiment. The steps in FIG. 6 are the same as those in FIG. 4, except for step S60 replacing step S46. As described above, in step S44, the acquired operation command is simulated. In step S45, in a case where the predetermined state has occurred on the trajectory (YES in step S45), the processing proceeds to step S60. In step S60, a correction proposal for the operation command is presented. The processing then returns to step S41. Details of the processing in step S60 is provided below with reference to FIG. 7.

FIG. 7 is a flowchart illustrating the processing of presenting a correction proposal for an operation command in step S60. As an example, a flow in which the predetermined state is contact with an obstacle is illustrated. First, in step S71, it is determined whether the type of the predetermined state resulting from the simulation contacts an obstacle. In a case where the type of the predetermined state contacts an obstacle (YES in step S71), the processing proceeds to step S72. In a case where the type of the predetermined state does not contact an obstacle (NO in step S71), the processing of the flowchart ends. In step S72, a robot trajectory that can avoid the contact is generated. An obstacle avoidance trajectory is generated using a trajectory generation algorithm such as, for example, Rapidry-Exploring Random Tree (RRT). Next, in step S73, an operation command for implementing the obstacle avoidance trajectory is generated. In step S74, notification of the generated operation command is provided to the user.

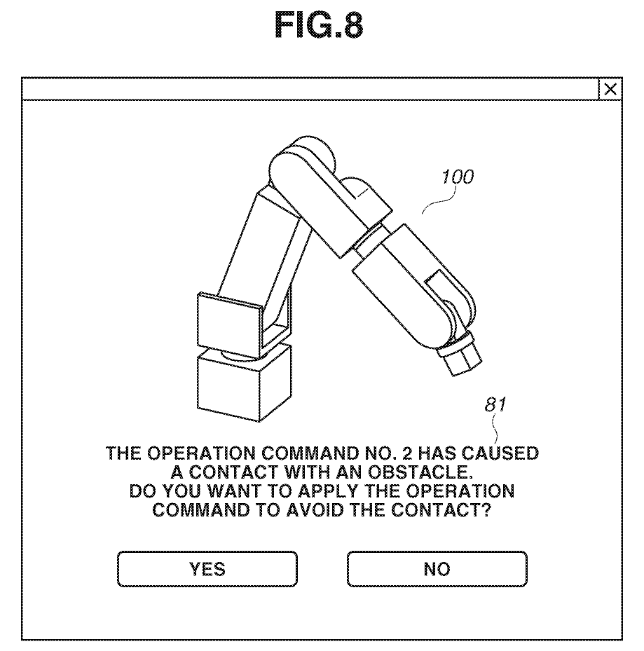

FIG. 8 illustrates a graphical user interface for presenting the correction proposal for the operation command. In this case, it is useful to present to the user a simulation result 81 of the operation command for avoiding the obstacle. In a case where the robot 100 contacts an obstacle in a plurality of operation commands, the interface illustrated in FIG. 8 may be displayed sequentially or in parallel.

In a case where the operation command causes the predetermined state due to the change of the teaching point condition, using the above-described method enables informing the user of a method for avoiding the predetermined state. Thus, it is possible to reduce the man-hours for checking the operation commands.

### Third Embodiment

In the above-described embodiments, the method performed in a case where the teaching point condition is changed has been described. In a third embodiment, even in a case where the teaching point condition is not changed or in a case where various conditions related to the teaching point are changed, it is possible to reduce the man-hours for checking the operation commands.

For example, when the condition of a component on which the robot 100 performs a task, such as gripping, is changed, the teaching point in which the relative position with the component is registered may be considered to have been changed. When the condition of a tool center point (TCP) is changed, the teaching point associated with the TCP may be considered to have been changed. When the installation condition of the robot 100 is changed, the teaching point associated with the robot 100 may be considered to have been changed.

In this case, the processing is executed starting from the processing of step S43 in FIG. 4. For example, in a case where there is a change in a component, the user may instruct the information processing apparatus 10 via a user interface or the like regarding the teaching point that is affected. A list in which components and teaching points are associated with each other is prepared in advance. By the user instructing the information processing apparatus 10 via a user interface or the like that the component has been changed, the related teaching point is regarded as having been changed.

### Fourth Embodiment

In the above-described embodiments, as illustrated in FIG. 2, an example has been described in which one teaching point is associated with one operation command, and the notification of an operation command that results in a state hindering the operation of the robot 100 due to the change of the teaching point condition is issued. In a fourth embodiment, a modification example thereof will be described.

For example, in a case where the robot 100 operates on a trajectory based on a plurality of teaching points by a single operation command and, when any of the plurality of teaching points is changed, the operation command may be regarded as a changed operation command. The trajectory based on the plurality of teaching points may be a trajectory in which individual trajectories connecting the plurality of teaching points are combined into one, or may be a trajectory in which the teaching points other than the start point and the end point from among the plurality of teaching points are connected to pass near them.

In the present embodiment, in step S43 (in which the operation command related to the teaching point changed by the user is acquired) in the flowchart of FIG. 4, the operation command including the teaching point changed by the user may be acquired as the changed operation command.

For example, in a case where a plurality of devices including the robot 100 operates in the same area, there is a possibility that interference between the robot 100 and other devices may occur. Thus, the devices may be synchronized with each other at predetermined synchronization timings. In this case, due to the change of one teaching point condition, there is a possibility that the operation timings between the plurality of the devices may shift, and interference may occur between the synchronization timings.

Assume, for example, that the operation command in which the teaching point condition has been changed is located between a first synchronization timing and a second synchronization timing. In addition, there are operation commands other than the operation command in which the teaching point condition has been changed between the first synchronization timing and the second synchronization timing. In such a case, in step S43 (in which the operation command related to the teaching point changed by the user is acquired) in FIG. 4, all of the plurality of operation commands located between the synchronization timings may be acquired as the operation commands changed by the user. This enables, even in the case where the operation timings are changed due to the plurality of operation commands, preventing interference between the devices in advance.

In the above-described example, not all operation commands between the synchronization timings may be acquired. For example, a predetermined number of consecutive operation commands located before and after the operation command including the change of the teaching point condition may be acquired as the changed operation commands. For example, the operation commands included within a predetermined time before and after the operation command in which the teaching point condition has been changed in the simulation may be acquired as the changed operation commands.

When the teaching points of the operation commands before and after the changed operation command are acquired as described above, the operation commands after the changed operation command are considered to have a greater influence on the operation. Therefore, the number of the operation commands to be acquired after the changed operation command may be greater than the number of the operation commands to be acquired before the changed operation command. The time period to be acquired after the changed operation command may be longer than the time period before the changed operation command. The above-described processing enables reducing the possibility of interference while reducing the calculation load compared to a case of acquiring all of the teaching points between the synchronization timings.

The above-described embodiments of the present disclosure include the following configurations.

### Item 1

An information processing method includes:

acquiring, in a case where a condition of a teaching point in an operation of a robot is changed, an operation command related to the teaching point of which the condition has been changed; and issuing a notification of the acquired operation command that causes a predetermined state.

### Item 2

The information processing method as set forth in Item 1, wherein the information processing method further includes simulating an operation of the robot based on the acquired operation command.

### Item 3

The information processing method as set forth in Item 1 or 2, wherein the notification is displayed on a display.

### Item 4

The information processing method as set forth in any one of Items 1 to 3, wherein issuing the notification of the operation command includes issuing a notification of a correction method for the operation command.

### Item 5

The information processing method as set forth in Item 4, wherein the notification of the correction method is displayed on a display.

### Item 6

The information processing method as set forth in any one of Items 1 to 5, wherein the information processing method further includes correcting the operation command in a case where the operation of the robot enters the predetermined state.

### Item 7

The information processing method as set forth in any one of Items 1 to 6, wherein the predetermined state is contact between a trajectory in the operation of the robot and an obstacle.

### Item 8

The information processing method as set forth in any one of Items 1 to 6, wherein the predetermined state is that a trajectory in the operation of the robot includes a singular point of the robot.

### Item 9

The information processing method as set forth in any one of Items 1 to 6, wherein the predetermined state includes a state where a trajectory in the operation of the robot is outside a movable range of the robot.

### Item 10

The information processing method as set forth in any one of Items 1 to 9, wherein information indicating whether the predetermined state is present is acquired from the operation command of which a start point has changed due to a change of the condition.

### Item 11

The information processing method as set forth in any one of Items 1 to 10, wherein in a case where a component handled by the robot is changed, a teaching point in which a relative position with respect to the component is registered is regarded as the teaching point of which the condition has been changed.

### Item 12

The information processing method as set forth in any one of Items 1 to 10, wherein in a case where a condition of a tool center point (TCP) of the robot is changed, a teaching point associated with the TCP is regarded as the teaching point of which the condition has been changed.

### Item 13

The information processing method as set forth in any one of Items 1 to 10, wherein in a case where an installation condition of the robot is changed, a teaching point associated with the robot is regarded as the teaching point of which the condition has been changed.

### Item 14

The information processing method as set forth in any one of Items 1 to 13, wherein in the case where the condition of the teaching point in the operation of the robot is changed, a plurality of operation commands including the operation command related to the teaching point of which the condition has been changed is acquired, and wherein a notification of an operation command that causes the predetermined state, from among the acquired plurality of operation commands, is issued.

### Item 15

The information processing method as set forth in Item 14, wherein in a case where the robot and at least one device that synchronizes with the robot at predetermined synchronization timings operate in a same area, and at least one of a plurality of operation commands between a first synchronization timing and a second synchronization timing includes the change, at least two operation commands including the operation command including the change, from among the plurality of operation commands included between the first synchronization timing and the second synchronization timing, are acquired.

### Item 16

The information processing method as set forth in Item 15, wherein the at least two operation commands include the operation command including the change, and an operation command consecutive to the operation command including the change.

### Item 17

The information processing method as set forth in Item 16, wherein acquiring the operation command related to the teaching point of which the condition has been changed also includes acquiring all of the plurality of operation commands included between the first synchronization timing and the second synchronization timing.

### Item 18

An information processing apparatus includes a processing unit, wherein the processing unit, in a case where a condition of a teaching point in an operation of a robot is changed, acquires an operation command related to the teaching point of which the condition has been changed and issues a notification of the acquired operation command that causes a predetermined state.

### Item 19

A program for causing a computer to execute the information processing method as set forth in any one of Items 1 to 17.

### Item 20

A computer-readable recording medium storing the program as set forth in Item 19.

### Item 21

An article manufacturing method includes manufacturing an article by operating the robot at the teaching point generated by the information processing method as set forth in any one of Items 1 to 17.

Using the technique in the above-described embodiments, in a case where an operation command causes a state that interferes with the operation of the robot due to a change in teaching point conditions, the operation command can be notified to the user, thereby reducing the man-hours for checking the operation command.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) ^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-199494, filed November 15, 2024, which is hereby incorporated by reference herein in its entirety.

What is claimed is:

1. An information processing method comprising:
acquiring, in a case where a condition of a teaching point in an operation of a robot is changed, an operation command related to the teaching point of which the condition has been changed; and
issuing a notification of the acquired operation command that causes a predetermined state.

2. The information processing method according to claim 1, further comprising simulating an operation of the robot based on the acquired operation command.

3. The information processing method according to claim 1, wherein the notification is displayed on a display.

4. The information processing method according to claim 1, wherein issuing the notification of the operation command includes issuing a notification of a correction method for the operation command.

5. The information processing method according to claim 4, wherein the notification of the correction method is displayed on a display.

6. The information processing method according to claim 1, further comprising correcting the operation command in a case where the operation of the robot enters the predetermined state.

7. The information processing method according to claim 1, wherein the predetermined state is contact between a trajectory in the operation of the robot and an obstacle.

8. The information processing method according to claim 1, wherein the predetermined state is that a trajectory in the operation of the robot includes a singular point of the robot.

9. The information processing method according to claim 1, wherein the predetermined state includes a state where a trajectory in the operation of the robot is outside a movable range of the robot.

10. The information processing method according to claim 1, wherein information indicating whether the predetermined state is present is acquired from the operation command of which a start point has changed due to a change of the condition.

11. The information processing method according to claim 1, wherein in a case where a component handled by the robot is changed, a teaching point in which a relative position with respect to the component is registered is regarded as the teaching point of which the condition has been changed.

12. The information processing method according to claim 1, wherein in a case where a condition of a tool center point of the robot is changed, a teaching point associated with the tool center point is regarded as the teaching point of which the condition has been changed.

13. The information processing method according to claim 1, wherein in a case where an installation condition of the robot is changed, a teaching point associated with the robot is regarded as the teaching point of which the condition has been changed.

14. The information processing method according to claim 1,
wherein in the case where the condition of the teaching point in the operation of the robot is changed, a plurality of operation commands including the operation command related to the teaching point of which the condition has been changed is acquired, and
wherein a notification of an operation command that causes the predetermined state, from among the acquired plurality of operation commands, is issued.

15. The information processing method according to claim 14,
wherein in a case where the robot and at least one device that synchronizes with the robot at predetermined synchronization timings operate in a same area and at least one of a plurality of operation commands between a first synchronization timing and a second synchronization timing includes the change, at least two operation commands including the operation command including the change, from among the plurality of operation commands included between the first synchronization timing and the second synchronization timing, are acquired.

16. The information processing method according to claim 15, wherein the at least two operation commands include the operation command including the change and an operation command consecutive to the operation command including the change.

17. The information processing method according to claim 16, wherein acquiring the operation command related to the teaching point of which the condition has been changed also includes acquiring all of the plurality of operation commands included between the first synchronization timing and the second synchronization timing.

18. A computer-readable recording medium storing a program for causing a computer to execute the information processing method according to claim 1.

19. An article manufacturing method comprising:
manufacturing an article by operating the robot at the teaching point generated by the information processing method according to claim 1.

20. An information processing apparatus comprising:
a processing unit,
wherein the processing unit, in a case where a condition of a teaching point in an operation of a robot is changed, acquires an operation command related to the teaching point of which the condition has been changed and issues a notification of the acquired operation command that causes a predetermined state.
